(19) United States
(12) Patent Application Publication
(10) Pub. No.: US 2017/0017365 A1
(43) Pub. Date: Jan. 19, 2017

(54) SYSTEM, METHOD, AND COMPUTER PROGRAM FOR VISUALLY ALTERING A USER INTERFACE BASED ON APPLICATION PROGRAM RUNTIME INFORMATION

(71) Applicant: Futurewei Technologies, Inc., Plano, TX (US)

(72) Inventors: Zongfang Lin, Santa Clara, CA (US); Reza Yazdani, Los Altos, CA (US); Chen Tian, Union City, CA (US); Ziang Hu, Union City, CA (US)

(21) Appl. No.: 14/799,510

(22) Filed: Jul. 14, 2015

(51) Int. Cl. G06F 3/0484; G06F 3/0482; G06F 3/0481

(52) U.S. Cl. CPC G06F 3/0484; G06F 3/04817; G06F 3/0482

(57) ABSTRACT

A system, method, and computer program product are provided for visually altering a graphical user interface based on application program runtime information. At least one indicia is presented on a graphical user interface of a device. Each indicia corresponds with an application program accessible utilizing the device. Further, runtime information associated with at least one application program is identified. At least a portion of the graphical user interface is visually altered in connection with a corresponding indicia on the at least one graphical user interface, based on the runtime information associated with the at least one application program.

### FIELD OF THE INVENTION

The present invention relates to graphical user interfaces, and more particularly to accessing application programs via graphical user interfaces.

### BACKGROUND

In modern operating system graphical user interfaces, icons are commonly used as a mechanism to access a corresponding application program or associated resource. Such icons may be selected by a user, to effect access to the corresponding application program. For example, a user may select a music player icon or music file icon to launch a corresponding music player program.

Currently, some icons visually convey a “live view” of content associated with the corresponding application program. For example, a weather application icon may include information about existing weather conditions. As another example, an email application icon may provide an indication of current status of internal content of the application associated with the icon, e.g. by displaying, on an upper right-hand corner of the icon, a number of unread messages, etc. As still yet another example, some icons may be color-coded by a user, for general organizational purposes.

These icons are limited, however, in that they fail to visually convey any runtime information in connection with the corresponding application program. There is thus a need for addressing these and/or other issues associated with the prior art.

### SUMMARY

A system, method, and computer program product are provided for generating or visually altering a graphical user interface based on application program runtime information. At least one indicia is presented on a graphical user interface of a device. Each indicia corresponds with an application program accessible utilizing the device. Further, runtime information associated with at least one application program is identified. To this end, at least a portion of the graphical user interface is visually altered in connection with a corresponding indicia on the at least one graphical user interface, based on the runtime information associated with the at least one application program.

### BRIEF DESCRIPTION OF THE DRAWINGS

FIG. 1 illustrates a method for visually altering a graphical user interface based on application program runtime information, in accordance with one embodiment.

FIG. 2 illustrates a framework for visually altering a graphical user interface, in accordance with one embodiment.

FIG. 3 illustrates a method for visually altering a graphical user interface, in accordance with one embodiment

FIG. 4 illustrates a desktop environment in which icons may be visually altered, in accordance with one embodiment.

FIG. 5 illustrates a mobile environment in which icons may be visually altered, in accordance with one embodiment.

FIG. 6A illustrates the manner in which a particular icon is surrounded by an outline color that may change based on changes in application program runtime information, in accordance with one particular embodiment.

FIG. 6B illustrates the manner in which a particular icon that is surrounded by an outline color may exhibit a color change based on a range of processor usage associated with a particular application, in accordance with one particular embodiment.

FIG. 6C illustrates the manner in which a particular icon is surrounded by an outline size that may change based on changes in application program runtime information, in accordance with one particular embodiment.

FIG. 6D illustrates the manner in which a particular icon that is surrounded by an outline may exhibit an outline size change based on a range of memory usage associated with a particular application, in accordance with one particular embodiment.

FIG. 6E illustrates the manner in which a particular icon includes a bar indicator that may change based on changes in processor usage in accordance with one particular embodiment.

FIG. 6F illustrates the manner in which a particular icon that includes a bar indicator may exhibit both a size and color change based on a range of processor usage associated with a particular application, in accordance with one particular embodiment.

FIG. 7 illustrates a menu for permitting user programmability of the visual alteration of icons based on runtime information, in accordance with one embodiment.

FIG. 8 illustrates a network architecture, in accordance with one possible embodiment.

FIG. 9 illustrates an exemplary system, in accordance with one embodiment.

### DETAILED DESCRIPTION

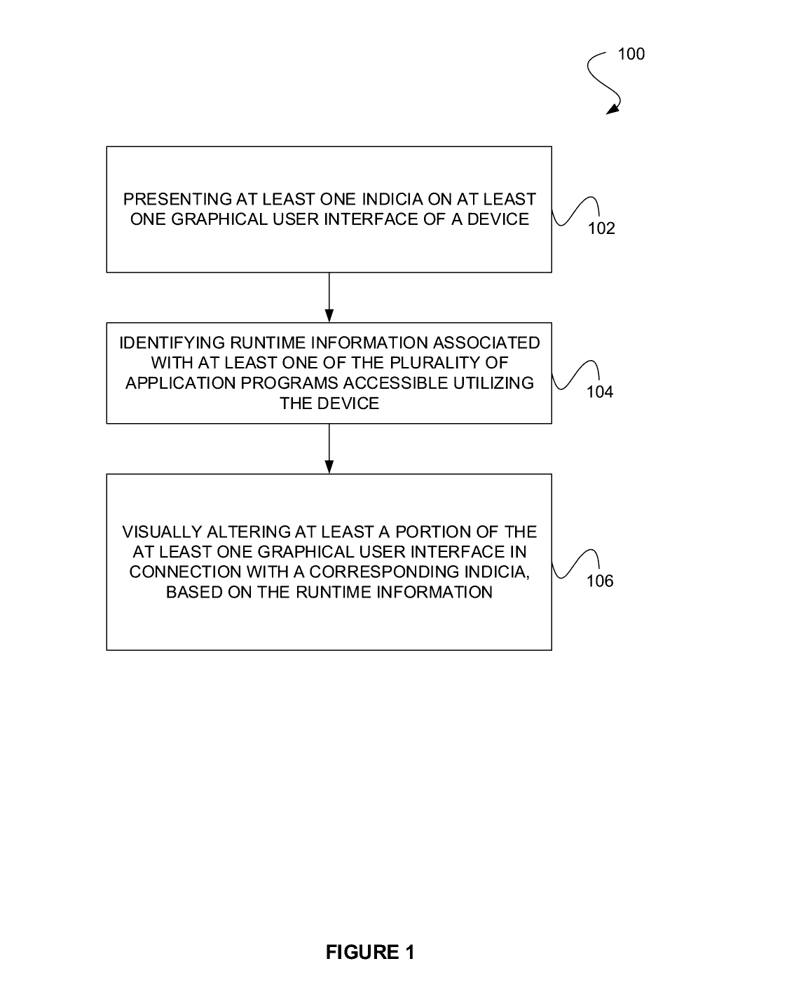

FIG. 1 illustrates a method 100 for visually altering a graphical user interface based on application program runtime information, in accordance with one embodiment. As shown in operation 102, at least one indicia is presented on a graphical user interface of a device. In the context of the present description, such indicia may refer to any graphical user interface element that is capable of corresponding with an application program accessible utilizing the device.

Just by way of example, in various embodiments, the indicia may include one or more visually perceptible icons, menu items, application identifiers, etc. In various embodiments, the indicia may correspond with the application program by graphically, textually, and/or otherwise identifying the corresponding application program and/or any resource/aspect thereof (e.g. application program file, folder, underlying device, etc.). During use in accordance with one embodiment, each application program may be accessible utilizing the device, in response to a selection of a corresponding one of the indicia.

In one embodiment, the application program may be installed on the device. In other embodiments, the application program may include an on-line application program installed on at least one server that is operable for communicating with the device over at least one network. In still other embodiments, a portion of the application program may be installed on the device and another portion of the application program may be installed on the server. Any application program may be utilized. Still yet, the device may include any desktop device, mobile device, or any other device that is capable of allowing access to application programs. Examples of other devices will be set forth in the context of subsequent figures.

As set forth in operation 104, runtime information associated with at least one of the application programs is identified. In the context of the present description, such runtime information may include any information associated with runtime operation of the application program. As an option, the runtime information may be passively received and/or actively retrieved from an operating system on which the application programs operate.

In various embodiments, the runtime information may indicate a usage amount of a processor (e.g. CPU load, etc.), storage, memory, power, network bandwidth, and/or any other resource. In another embodiment, the runtime information indicates a runtime status. For example, the runtime status may indicate whether the application program is running via a background process. As another example, the runtime status may indicate whether the application program has failed (e.g., crashed, stalled, frozen, cease to be lively, etc.).

As shown in operation 106, at least a portion of the graphical user interface is visually altered in connection with a corresponding indicia on the at least one graphical user interface, based on the runtime information associated with the at least one application program. While any portion of the graphical user interface (e.g. portion outside the indicia, etc.) may be visually altered in connection with the corresponding indicia, the corresponding indicia itself may be visually altered on the graphical user interface of the device, in accordance with one embodiment.

In the context of the present description, the aforementioned visual alteration may include any alteration of any portion of the graphical user interface that results in any visually perceptible manifestation. Just by way of illustration, such visual alteration may involve a color, a shape (e.g. triangle, dot, bar, pie, custom or predefined shape, etc.), an animation, etc. In one embodiment, at least one aspect of the visual alteration may be user programmable. It is to be appreciated that other embodiments are contemplated whereby one or more aspects of the visual alteration are predetermined.

Further, in one embodiment, the visual alteration may affect a single aspect of the aforementioned portion of the graphical user interface, while, in other embodiments, the visual alteration may involve a plurality of aspects. In different embodiments, the at least one aspect of the visual alteration may include a shape to be visually altered, a color to be visually altered, an animation to be visually altered, an activation of the visual alteration, a deactivation of the visual alteration, a location of the visual alteration, an interval with which the runtime information is updated, and/or any other aspect, for that matter.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

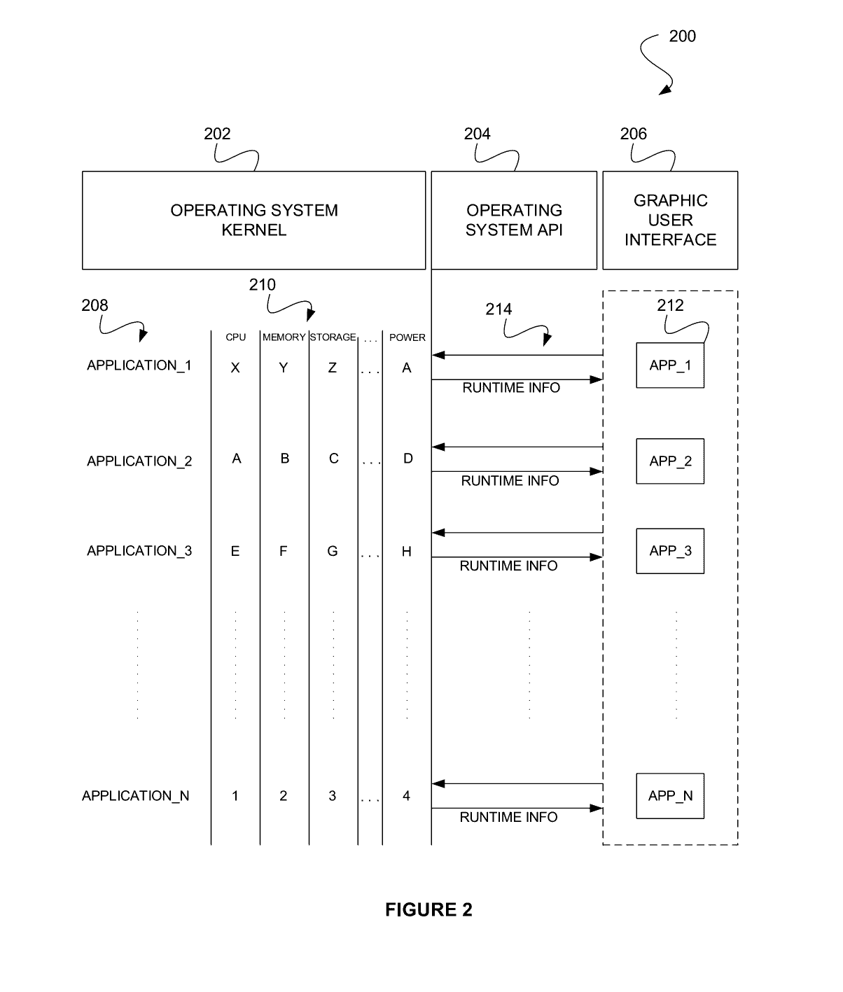

FIG. 2 illustrates a framework 200 for visually altering a graphical user interface, in accordance with one embodiment. As an option, the framework 200 may be implemented in the context of the details of any of the previous and/or subsequent figure(s). However, it is to be appreciated that the framework 200 may be implemented in the context of any desired environment.

As shown, provided is an operating system kernel 202, an operating system application program interface (API) 204, and a graphical user interface 206. The operating system kernel 202 monitors one or more applications 208. Specifically, a plurality of runtime parameters 210 are tracked for each of the applications 208, in the manner shown. Still yet, the graphical user interface 206 displays a plurality of icons 212 corresponding to each of the applications 208, for allowing access to the applications 208 in response to the selection thereof.

The operating system API 204 serves to communicate runtime information 214 reflecting one or more of the runtime parameters 210 for visual conveyance or display via the graphical user interface 206. As mentioned earlier, this may be accomplished, either at the active request via the graphical user interface 206, or via passive receipt as a function of a change in one or more of the runtime parameters 210. In either case, the request and/or the passive receipt may be triggered based on any desired event. For example, the request may be triggered based on a predetermined or programmable interval, and/or any event (e.g., opening of the graphical user interface 206, display of a portion (e.g. page, etc.) of the graphical user interface 206 including the associated icon 212, etc.). Still yet, the passive receipt may be triggered based on a monitored event that occurs at the aforementioned predetermined or programmable interval, and/or immediately upon a detected change.

To this end, the graphical user interface 206 may visually alter the icons 212 based on the runtime information 214. This may thereby provide a user with conveniently gleaned insight into the runtime parameters 210 associated with the corresponding applications 208. As an option, this may be accomplished without necessarily requiring the user to access a task manager or the like via one or more menu selections that inconveniently divert the user from the icons 212 and the convenient application program access thereby provided. Embodiments are contemplated where such runtime information 214 may be accessed using a variety of different techniques.

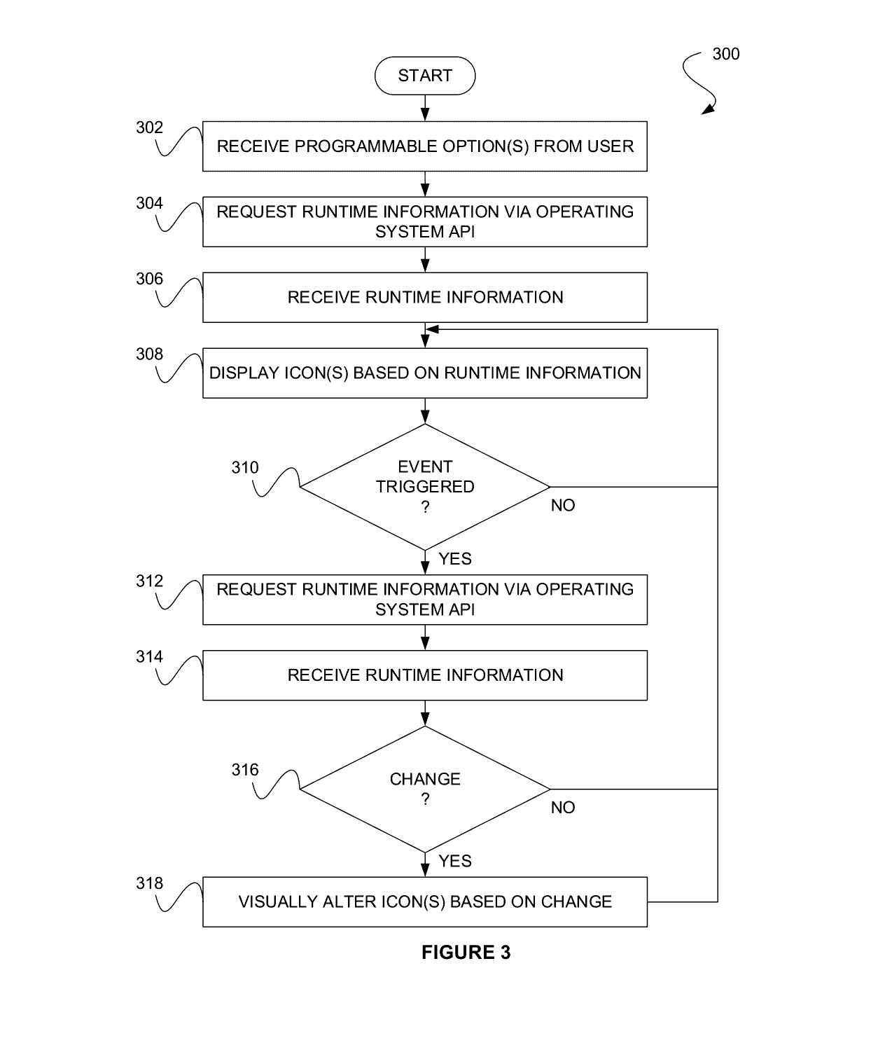

FIG. 3 illustrates a method 300 for visually altering a graphical user interface, in accordance with one embodiment. As an option, the method 300 may be implemented in the context of the details of any of the previous and/or subsequent figure(s). However, the method 300 may be implemented in the context of any desired environment.

As indicated in operation 302, an optional set-up may be effected by receiving programmable option(s) or inputs from a user. In one embodiment, this may be accomplished utilizing a menu for selecting one or more aspects of the runtime information/parameters, visual alteration, etc. To this end, the user is permitted to configure what runtime information/parameters trigger the visual alteration; how, when, where, etc. the visual alteration is effected; and/or any other aspect of the visual alteration, for that matter. Other embodiments are contemplated whereby user programmability is forgone in the interest of simplifying a user experience.

Runtime information is requested, as indicated in operation 304. In one embodiment, this may be accomplished by issuing requests via an operating system API (e.g. operating system API 204 of the framework 200 of FIG. 2, etc.). In response to such request of operation 304, the runtime information is received in operation 306.

To this end, any relevant icon(s) may be displayed via a graphical user interface. See, for example, the graphical user interface 206 of the framework 200 of FIG. 2. As indicated in operation 308, such display of the icon(s) is specifically based on the received runtime information, thereby giving a user visual insight into the runtime state associated with the application(s) accessible via the corresponding icon(s).

Once the icon(s) is specifically displayed based on the received runtime information, the method 300 continues by determining whether such visual presentation requires any alteration due to any update and/or change in the runtime information. As mentioned earlier, such alteration may be triggered based on a real-time detection of an update and/or change in the runtime information, or any other trigger event (e.g., passive monitor/active request, predetermined/programmable interval, access to the graphical user interface, display of relevant icon(s), etc.). Any and all of the aforementioned event triggers (and any other(s) not described) are contemplated in decision 310.

If it is determined in decision 310 that an event trigger has occurred, the runtime information is then requested in operation 312 such that runtime information is received in operation 314. While such runtime request/receipt is disclosed in method 300, it is again emphasized that, in other embodiments, such operation is supplemented with and/or omitted in favor of receiving runtime information automatically and/or passively in the manner discussed above. This applies not only to update operations 312-314, but analogous initial set-up operations 304-306, as well. In various embodiments, each of such set-up/update operations may be passive and/or active in nature. Hybrid approaches are also contemplated. For example, the operations 304-306 may be initiated via an active request/receipt approach, while the following operations 312-314 may follow a passive approach.

To this end, to the extent that there is any change in the runtime information, per decision 316, one or more icons are visually altered based on such change, as noted in operation 318. Thus, a user may conveniently glean insight into the runtime parameters associated with the corresponding applications, without necessarily requiring access to a task manager or the like which would otherwise require visual diversion of the user from the icons. These optional advantages may be afforded in connection with regular access of the application program(s) via the icon(s), debugging, and/or any other context, for that matter.

A variety of examples in which the graphical user interface may be visually altered in connection with the icon(s) will now be set forth, in accordance with a variety of possible embodiments. It should be noted that such examples are set forth for illustrative purposes only and should not be construed as limiting in any manner. For example, any feature of one embodiment may be implemented with or without any other feature of any other one or more embodiments.

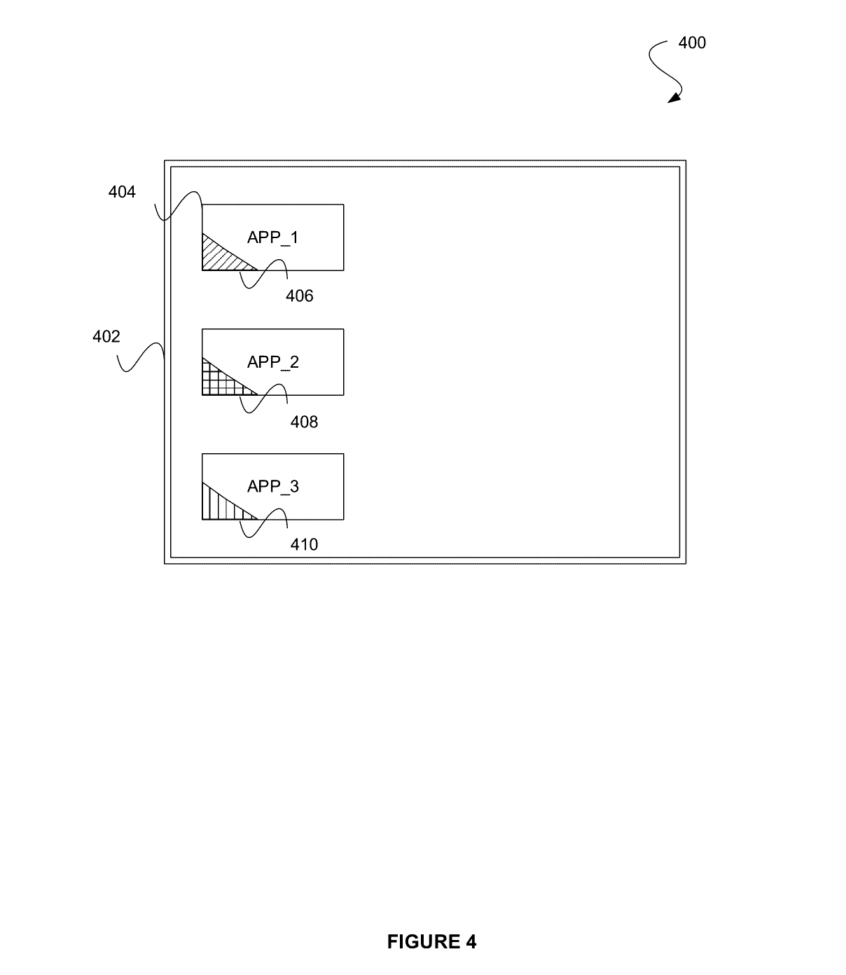

FIG. 4 illustrates a desktop environment 400 in which icons may be visually altered, in accordance with one embodiment. As an option, the desktop environment 400 may be implemented in the context of the details of any of the previous and/or subsequent figure(s). However, the desktop environment 400 may be implemented in the context of any desired environment.

As shown, the desktop environment 400 includes a desktop 402 which may, for example, be implemented on a desktop computer. Also shown is a plurality of application program icons 404. The application program icons 404 are visually altered (based on runtime information) by altering a color of a portion thereof.

Specifically, a bottom left-hand corner of each of the application program icons 404 can be colored differently in accordance with the runtime information associated with the corresponding application program. Since the application program icons 404 are rectilinear (e.g. rectangular, etc.), the colored portion takes the form of a triangle. As illustrated, such color may include, for example, a first color 406 representative of first runtime information, a second color 408 representative of second runtime information, and a third color 410 representative of third runtime information, etc. Alternatively, the display may be in the form of differing linear/non-linear displays, including the diagonal lines associated with color 406, cross-hatching associated with color 408, and vertical lines associated with color 410.

Not all of the application program icons 404 necessarily need include the visual alterations. For example, a first subset of the application program icons 404 may be visually altered (e.g. based on user programmability, runtime information, etc.) and a second subset of the application program icons 404 may not necessarily be visually altered. Further, while the application program icons 404 are illustrated in a desktop environment 400, it should be noted that these visual alterations may also be implemented in a mobile environment, or any other environment, for that matter.

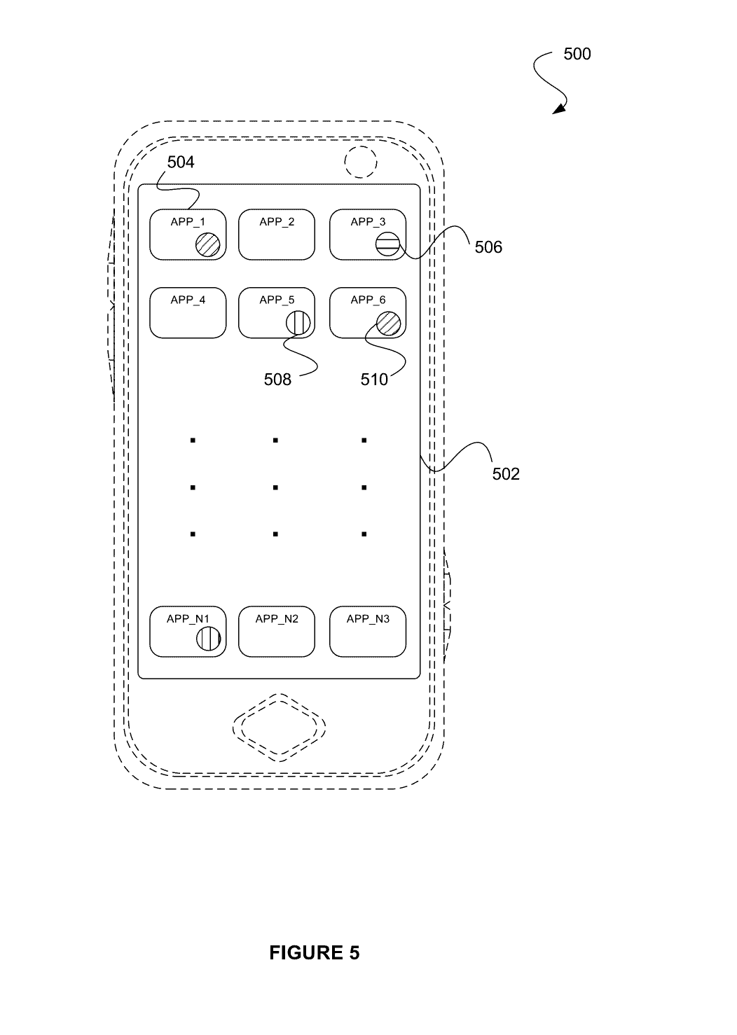

FIG. 5 illustrates a mobile environment 500 in which icons may be visually altered, in accordance with one embodiment. As an option, the mobile environment 500 may be implemented in the context of the details of any of the previous and/or subsequent figure(s). Of course, however, the mobile environment 500 may be implemented in the context of any desired environment.

As shown, the mobile environment 500 includes a mobile interface 502 which may, for example, be implemented on a phone. Also shown is a plurality of application program icons 504. The application program icons 504 are visually altered (based on runtime information) by altering a color (or graphic) of a portion thereof.

Specifically, each of the application program icons 504 is equipped with colored circles 506, 508, 510 which are colored differently based on the runtime information associated with the corresponding application program. As illustrated, such color circles may include, for example, a first colored circle 506 of a first color representative of first runtime information, a second colored circle 508 of a second color representative of second runtime information, and a third colored circle 510 of a third color representative of third runtime information, etc.

As shown, all of the application program icons 504 need not necessarily include the colored circles (although they may in other embodiments). Further, while the application program icons 504 are illustrated in a mobile environment 400, it should be noted that these visual alterations may also be implemented in a desktop environment, or any other environment, for that matter.

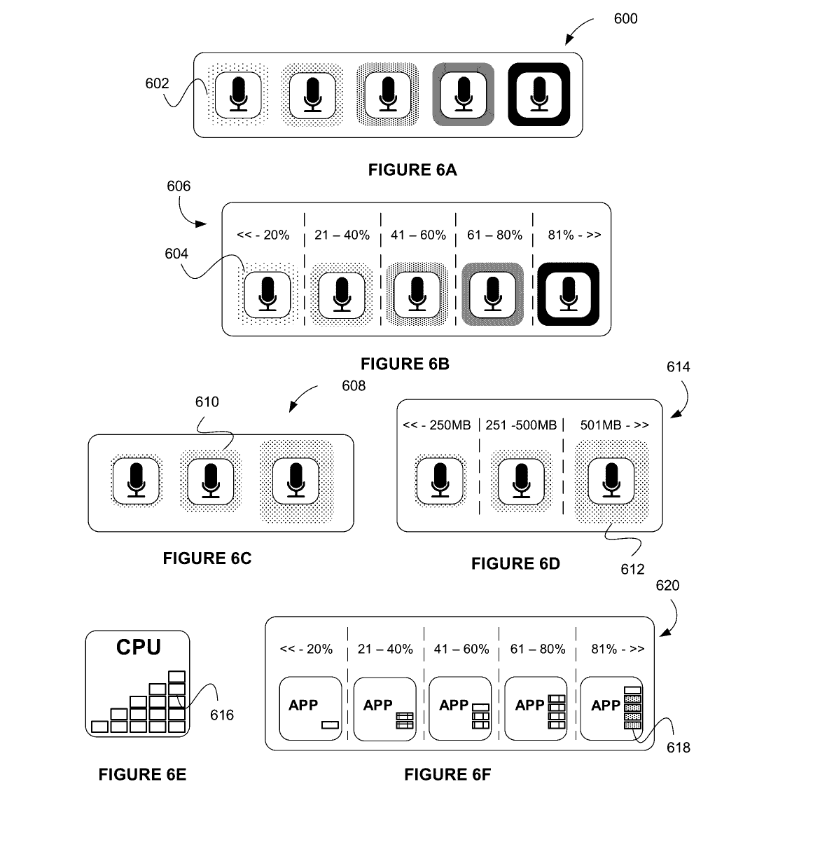

FIGS. 6A-F show different examples of icons and the manner in which they may be visually altered, in accordance with various embodiments. As an option, such examples may be implemented in the context of the details of any of the previous and/or subsequent figure(s). Of course, however, these examples may be implemented in the context of any desired environment.

As shown, FIG. 6A illustrates the manner in which a particular icon 600 is surrounded by an outline color 602 that may change based on changes in application program runtime information, in accordance with one particular embodiment. Further, FIG. 6B illustrates the manner in which a particular icon that is surrounded by an outline color 604 may exhibit a color change based on a range of processor usage 606 associated with a particular application, in accordance with one particular embodiment.

Further, FIG. 6C illustrates the manner in which a particular icon 608 is surrounded by an outline size 610 that may change based on changes in application program runtime information, in accordance with one particular embodiment. Further, FIG. 6D illustrates the manner in which a particular icon that is surrounded by an outline 612 may exhibit an outline size change based on a range of memory usage 614 associated with a particular application, in accordance with one particular embodiment. While not shown, a transparency, intensity, etc. may be visually altered, as well, to represent the runtime information.

Even still, FIG. 6E illustrates the manner in which a particular icon includes a bar indicator 616 that may change based on changes in processor usage in accordance with one particular embodiment. Further, FIG. 6F illustrates the manner in which a particular icon that includes a bar indicator 618 may exhibit both a size and color change based on a range 620 of processor usage associated with a particular application, in accordance with one particular embodiment.

While not shown, any of the embodiments described herein may include animation. For example, in one embodiment, an animated runner may be shown in connection with an icon. Further, such animated runner may be visually altered in a manner that a speed with which the runner runs is a function of runtime information. In various embodiments, the animation may be incorporated into the icon (e.g. incorporated into a portion or component of the graphics of the icon), or simply be incorporated as overlay or adjacent figure, symbol, etc. Other examples of animation are set forth below.

For example, an icon or portion thereof may be configured to blink and/or flash. Such animation, for instance, can be used to indicate if an application program is running. As another example, an icon or portion thereof may be configured to jump, for similar purposes. It should be noted that the jump direction is not limited to vertical movement, but can be other directions, as well (e.g. horizontal direction, and directions between horizontal and vertical). As yet another example, an icon or portion thereof may be configured to rotate.

In one possible embodiment, an animated icon (e.g., a man, animal, etc.) may be shown to be jogging, walking, stopping, resting, etc. to reflect runtime information. Still yet, in other embodiments, a dot, circle, object, etc. may circumnavigate an icon for similar purposes. Any of a variety of types of animation is contemplated, in different embodiments.

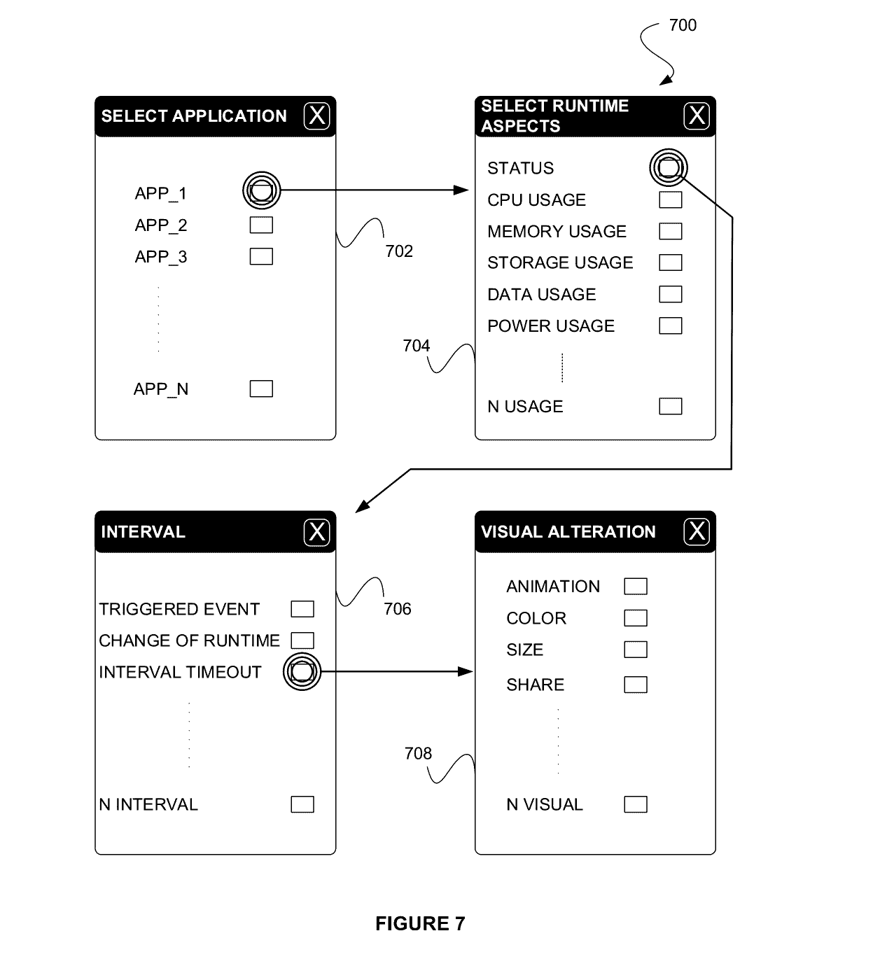

FIG. 7 illustrates a menu 700 for permitting user programmability of the visual alteration of icons based on runtime information, in accordance with one embodiment. As an option, the menu 700 may be implemented in the context of the details of any of the previous and/or subsequent figure(s). The menu 700 may be implemented in the context of any desired environment.

As shown, a first menu interface 702 is shown to include a plurality of applications that are available for selection. Using the first menu interface 702, a user is permitted to select one or more or all of the applications listed for being subject to visual alteration based on runtime information. In response to the selection of at least one application in the first menu interface 702, a second menu interface 704 is displayed.

As shown, such second menu interface 704 permits a user to select one or more aspects of runtime operation in connection with the selected application program(s). After such selection, a third menu interface 706 is displayed which allows the user to alter the manner in which the runtime information is updated. Finally, a fourth menu interface 708 is provided for allowing the user to select one or more ways in which the icon(s) or associated graphical user interface may be visually altered based on the runtime information.

While not shown, one or more additional settings may be provided to allow a user to selectively disable (e.g. turn off) or otherwise modify the visual appearance of one or more of the icon(s), per the desires of the user. Even still, other features such as a legend that defines the meaning of the visual alteration may be provided in a setting menu, on the graphical user interface on which the icon(s) reside, and/or in any other location.

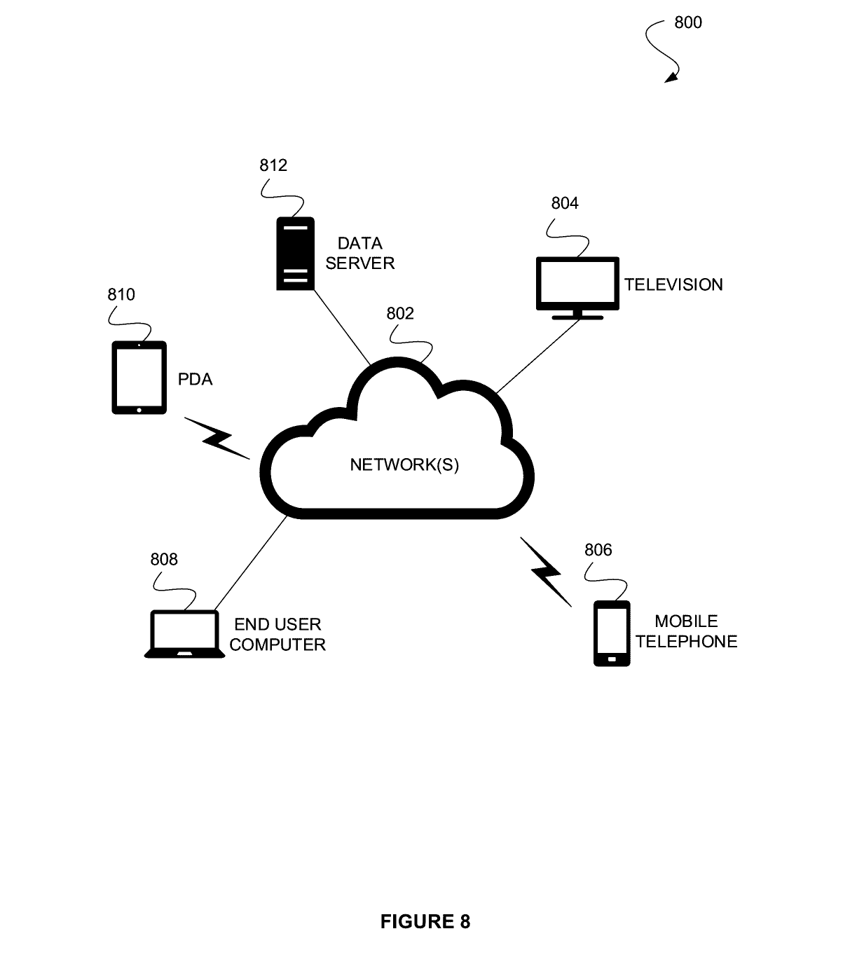

FIG. 8 illustrates a network architecture 800, in accordance with one embodiment. As shown, at least one network 802 is provided. In the context of the present network architecture 800, the network 802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 802 may be provided.

Coupled to the network 802 is a plurality of devices. For example, a server computer 804 and an end user computer 806 may be coupled to the network 802 for communication purposes Such end user computer 806 may include a desktop computer, lap-top computer, and/or any other type of logic. Still yet, various other devices may be coupled to the network 802 including a personal digital assistant (PDA) device 808, a mobile phone device 810, a television 812, etc.

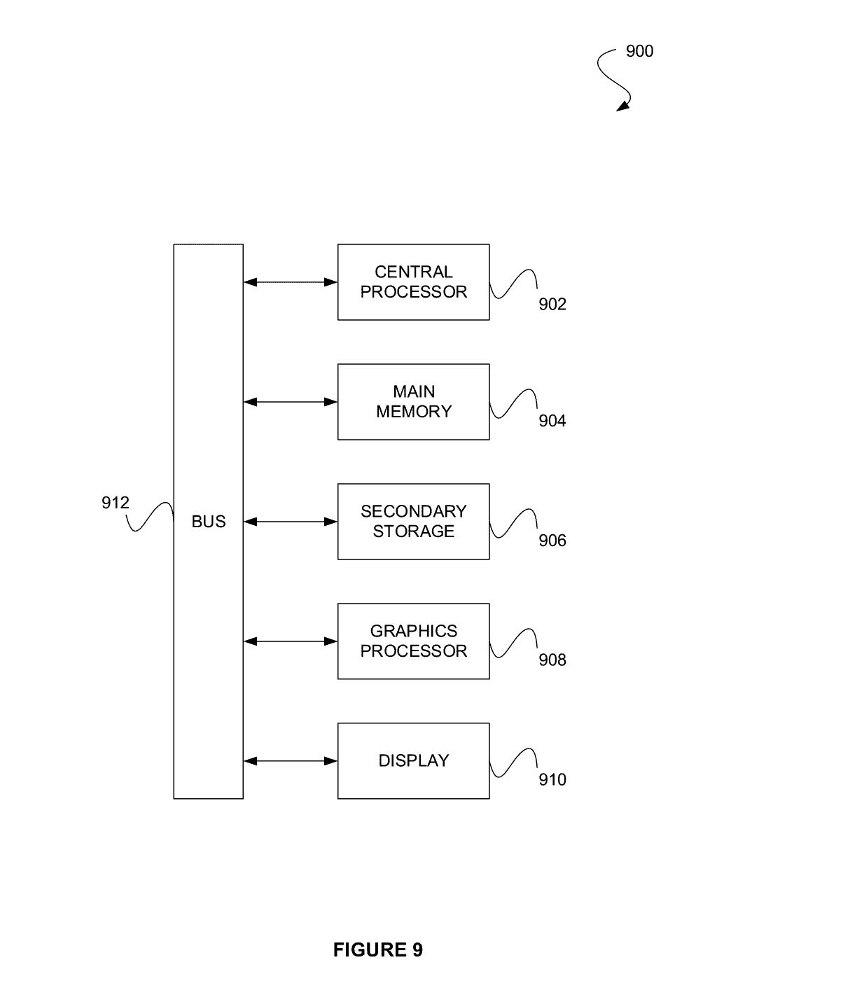

FIG. 9 illustrates an exemplary system 900, in accordance with one embodiment. As an option, the system 900 may be implemented in the context of any of the devices of the network architecture 800 of FIG. 8. Of course, the system 900 may be implemented in any desired environment.

As shown, a system 900 is provided including at least one central processor 901 which is communicatively coupled to a communication bus 902. The system 900 also includes main memory 904 [e.g., hard disk drive, solid state drive, random access memory (RAM), etc.]. The system 900 also includes a graphics processor 908 and a display 910.

The system 900 may also include a secondary storage 906. The secondary storage 906 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 904, the secondary storage 906, and/or any other memory, for that matter. Such computer programs, when executed, enable the system 900 to perform various functions (as set forth above, for example). Memory 904, secondary storage 906 and/or any other storage are possible examples of tangible computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer program product embodied on a non-transitory computer readable medium, comprising:
code for presenting at least one indicia on at least one graphical user interface of a device, each indicia corresponding with one of a plurality of application programs accessible utilizing the device;
code for identifying runtime information associated with at least one of the plurality of application programs accessible utilizing the device; and
code for visually altering at least a portion of the at least one graphical user interface of the device in connection with a corresponding indicia on the at least one graphical user interface of the device, based on the runtime information associated with the at least one application program.

2. The computer program product of claim 1, wherein the indicia includes one or more visually perceptible icons.

3. The computer program product of claim 1, wherein the application programs are installed on the device.

4. The computer program product of claim 1, wherein the application programs include on-line application programs installed on at least one server that is operable for communicating with the device over at least one network.

5. The computer program product of claim 1, wherein the computer program product is operable such that each of application programs is accessible utilizing the device, in response to a selection of a corresponding one of the indicia.

6. The computer program product of claim 1, wherein the computer program product is operable such that the runtime information is received from an operating system on which the application programs operate.

7. The computer program product of claim 1, wherein the computer program product is operable such that the runtime information indicates an amount of processor usage.

8. The computer program product of claim 1, wherein the computer program product is operable such that the runtime information indicates an amount of storage usage.

9. The computer program product of claim 1, wherein the computer program product is operable such that the runtime information indicates an amount of memory usage.

10. The computer program product of claim 1, wherein the computer program product is operable such that the runtime information indicates an amount of power usage.

11. The computer program product of claim 1, wherein the computer program product is operable such that the runtime information indicates an amount of bandwidth usage.

12. The computer program product of claim 1, wherein the computer program product is operable such that the runtime information indicates a runtime status.

13. The computer program product of claim 12, wherein the computer program product is operable such that the runtime status indicates whether the at least one application program is running via a background process.

14. The computer program product of claim 12, wherein the computer program product is operable such that the runtime status indicates whether the at least one application program has failed.

15. The computer program product of claim 1, wherein the computer program product is operable such that the at least portion of the at least one graphical user interface is visually altered by visually altering the corresponding indicia on the at least one graphical user interface of the device.

16. The computer program product of claim 1, wherein the computer program product is operable such that the visual alteration includes a visual alternation of a plurality of aspects of the at least portion of the at least one graphical user interface.

17. The computer program product of claim 1, wherein the computer program product is operable such that the visual alteration includes visual alteration of a color.

18. The computer program product of claim 1, wherein the computer program product is operable such that the visual alteration includes visual alteration of a shape.

19. The computer program product of claim 1, wherein the computer program product is operable such that the visual alteration includes visual alteration of an animation.

20. The computer program product of claim 1, wherein the computer program product is operable such that at least one aspect of the visual alteration is user programmable.

21. The computer program product of claim 20, wherein the at least one aspect of the visual alteration includes one or more of the following: a shape to be visually altered, a color to be visually altered, an animation to be visually altered, an activation of the visual alteration, a deactivation of the visual alteration, a location of the visual alteration, or an interval with which the runtime information is updated.

22. A method, comprising:
presenting at least one indicia on at least one graphical user interface of a device, each indicia corresponding with one of a plurality of application programs accessible utilizing the device;
identifying runtime information associated with at least one of the plurality of application programs accessible utilizing the device; and
visually altering at least a portion of the at least one graphical user interface of the device in connection with a corresponding indicia on the at least one graphical user interface of the device, based on the runtime information associated with the at least one application program.

23. An apparatus, comprising:
at least one processor; and
a display communicatively coupled to the at least one processor;
said display configured to present at least one indicia, each indicia corresponding with one of a plurality of application programs; and
said at least one processor configured to identify runtime information associated with at least one of the plurality of application programs and visually alter at least a portion of the display in connection with a corresponding indicia, based on the runtime information associated with the at least one application program.

24. The apparatus of claim 23, wherein the indicia includes at least one visually perceptible icon.

25. The apparatus of claim 23, wherein the application programs are installed on the apparatus.

26. The apparatus of claim 23, wherein the application programs include on-line application programs installed on at least one server that is operable for communicating with the apparatus over at least one network.

27. The apparatus of claim 23, wherein the apparatus is operable such that each of application programs is accessible utilizing the apparatus, in response to a selection of a corresponding one of the indicia.

28. The apparatus of claim 23, wherein the apparatus is operable such that the runtime information is received from an operating system on which the application programs operate.

29. The apparatus of claim 23, wherein the apparatus is operable such that the runtime information indicates an amount of processor usage.

30. The apparatus of claim 23, wherein the apparatus is operable such that the runtime information indicates an amount of storage usage.

31. The apparatus of claim 23, wherein the apparatus is operable such that the runtime information indicates an amount of memory usage.

32. The apparatus of claim 23, wherein the apparatus is operable such that the runtime information indicates an amount of power usage.

33. The apparatus of claim 23, wherein the apparatus is operable such that the runtime information indicates an amount of bandwidth usage.

34. The apparatus of claim 23, wherein the apparatus is operable such at the runtime information indicates a runtime status.

35. The apparatus of claim 34, wherein the apparatus is operable such that the runtime status indicates whether the at least one application program is running via a background process.

36. The apparatus of claim 34, wherein the apparatus is operable such that the runtime status indicates whether the at least one application program has failed.

37. The apparatus of claim 23, wherein the apparatus is operable such that the at least portion of the display is visually altered by visually altering the corresponding indicia.

38. The apparatus of claim 23, wherein the apparatus is operable such that the visual alteration includes a visual alternation of a plurality of aspects of the at least portion of the display.

39. The apparatus of claim 23, wherein the apparatus is operable such that the visual alteration includes visual alteration of a color.

40. The apparatus of claim 23, wherein the apparatus is operable such that the visual alteration includes visual alteration of a shape.

41. The apparatus of claim 23, wherein the apparatus is operable such that the visual alteration includes visual alteration of a size.

42. The apparatus of claim 23, wherein the apparatus is operable such that the visual alteration includes visual alteration of an animation.

43. The apparatus of claim 23, wherein the apparatus is operable such that at least one aspect of the visual alteration is user programmable.

44. The apparatus of claim 43, wherein the at least one aspect of the visual alteration includes one or more of the following: a shape to be visually altered, a color to be visually altered, an animation to be visually altered, an activation of the visual alteration, a deactivation of the visual alteration, a location of the visual alteration, or an interval with which the runtime information is updated.
